(19) United States
(12) Patent Application Publication
(10) Pub. No.: US 2017/0110906 A1
(43) Pub. Date: Apr. 20, 2017

(54) SYSTEM FOR INCORPORATING A RENEWABLE POWER SOURCE AND BATTERY BACKUP WITH A UTILITY GRID

(71) Applicant: Bruce de Jong, RenoReno, NV (US)

(72) Inventor: Bruce de Jong, RenoReno, NV (US)

(21) Appl. No.: 14/884,687

(22) Filed: Oct. 15, 2015

(51) Int. Cl. H02J 9/06

(52) U.S. Cl. CPC H02J 9/061

(57) ABSTRACT

A system includes a first input being configured to receive power produced from a renewable power source. A second input is configured to receive utility power from a utility power source. A first output is configured to output power to a consumer load. A second output is configured to output excess power to a load, wherein the excess power is an excess of power produced from the renewable power source after supplying the consumer load with power produced from the renewable power source.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to electrical grids with backup systems. More particularly, the invention relates to adding electrical backup systems to a net metered electrical grid.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Renewable energy systems owned by electricity consumers are often net metered. Net metering allows for owners of renewable energy systems to send excess energy produced by their renewable energy systems onto the local power grid during times of high power usage. The renewable energy system owner may then be awarded credits or other incentives from their power utility provider.

Traditional net metered electrical grids do not typically allow back up power systems, such as batteries, to be installed in renewable energy systems connected to the grid. One of the reasons for prohibiting back up power systems is due to the risk of a back up power system feeding power back into the electrical grid while it is down for maintenance, presenting a hazard for electrical grid maintenance workers.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typical renewable energy systems may often require a power utility company's safety approval and/or require an expensive installation of a net metering device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary electrical back up system, in accordance with an embodiment of the present invention; and

FIG. 2 illustrates an exemplary electrical back up system connected to a power grid, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of ” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Some embodiments of the present invention and variations thereof, relate to electrical backup systems. In one embodiment of the invention, an electrical back up system is installed into a power grid.

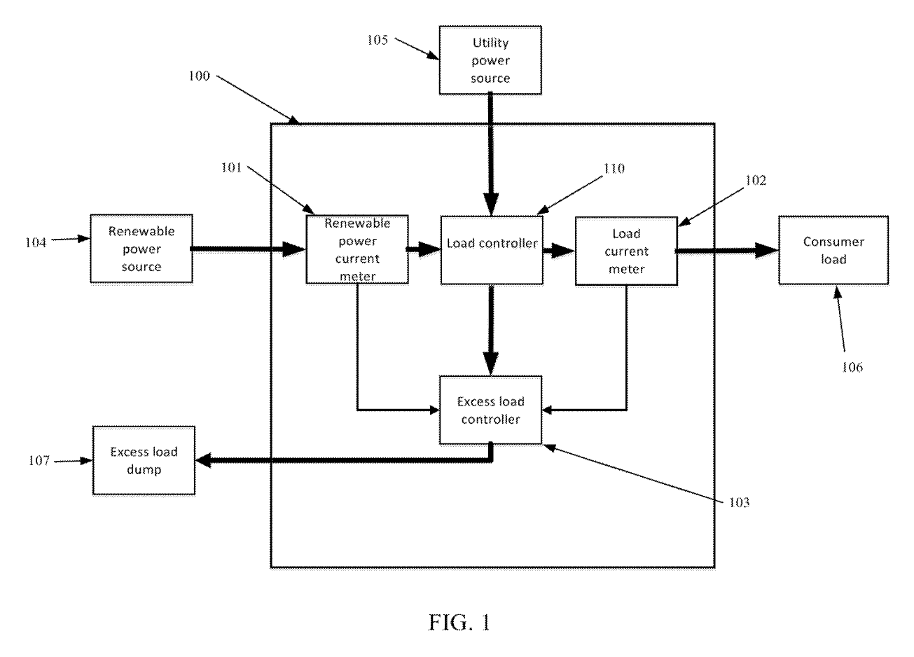

FIG. 1 illustrates an exemplary electrical back up system, in accordance with an embodiment of the present invention. Electrical back up system 100 may comprise a renewable power current meter 101, a load current meter 102, and an excess load controller 103. A renewable power source 104 and a utility power source 105 may provide electrical power to electrical back up system 100. Power may be regulated through electrical back up system 100 and used to power consumer load 106. Excess power may be sent from electrical back up system 100 to an excess load dump 107.

Electrical back up system 100 may be easily installed in a user's personal electric grid, henceforth known as ‘on grid’, by removing any net metering devices present on grid and installing electrical back up system 100 in place of the net metering devices. In the present embodiment, the utility power source 105 may enter back up system 100 as a second power input source. Output power from load current meter 102 may connect to a main panel of consumer load 106. Output power may not be feed back to the utility power source 105. Electrical back up system 100 may be configured to integrate with a power grid without having to replace any existing power grid hardware such as inverters.

During typical operation, power is provided to electrical back up system 100 from a renewable power source 104 and a utility power source 105. Power from renewable power source 104 may be metered by renewable power current meter 101. A portion or all of the combined power from renewable power source 104 and utility power source 105 may be sent through load current meter 102 and delivered to consumer load 106. Information on the voltage and current of the power passing through renewable power current meter 101 and load current meter 102 may be sent to an excess load controller 103. Excess load controller 103 may direct excess power in electrical back up power system 100 to an excess load dump 107. In some embodiments, excess load dump 107 may include, but not limited to, fans, ac, heater, lights, and ground waste.

Power load may be balanced by configuring electrical back up system 100. In the present embodiment, a load controller 110 may direct power from utility power source 105 and renewable power source 104. In some embodiments load controller may be a terminal block or junction box. In a non-limiting example, if the power required by consumer load 106 is greater than a power output of renewable power source 140, then utility power source 105 may supplement that short coming. In the present embodiment, excess load controller may not feed excess load dump when utility power source 105 is supplying power. Electrical back up system 100 may help utility power source 105 load by not drawing power when renewable power source 104 is providing power at a certain level.

It may be appreciated by a person with ordinary skill in the art that any number of renewable power current meters 101 and/or load current meter 102 may be present in electrical back up system 100. In some embodiments, information from renewable power current meters 101 and/or load current meter 102 may be displayed for indicating system performance. In some embodiments, with systems with multiple renewable power sources 104, there may be one or more renewable power current meters 101 and/or load current meters 102 coupled to each renewable power source 104 and/or utility power source 105, respectively. In some embodiments, multiple backup systems 100 may be operated in parallel. In another embodiment of the present invention a plurality of renewable power sources 104 are coupled to a plurality of renewable power current meters 101. Excess load controller 103 receives power information from the plurality of renewable power current meters 101 to determine how excess power load is handled. In some embodiments, multiple renewable power sources 104 may be connected to a single renewable power current meter 101. It may be appreciated by a person with ordinary skill in the art that renewable power current meter 101 and load current meter 102 are not limited to sending only power data to excess load controller 103. Renewable power current meter 101 and load current meter 102 may be devices capable of sending information such as, but not limited to, power source metrics, time, environmental conditions, etc. In another embodiment of the present invention, renewable power current meter 101 and load current meter 102 may send statistical information on the power output of renewable power source 104 and the load of consumer load 106, respectively.

It may be appreciated by a person with ordinary skill in the art that excess load controller 103 may be configured to run any algorithm to handle excess load. Excess load controller 103 may be configured to convert excess load to a certain voltage and/or current, dump load under certain conditions, favor a specific excess load dump 107, etc. In some other embodiments, excess load controller 103 may be configured to dump excess power to a net meter. In another embodiment of the present invention, excess load controller 103 may convert excess load power to a lower voltage and/or current according to a safety standard before sending the converted excess load power to excess load dump 107.

It may be appreciated by a person with ordinary skill in the art that one or more elements of electricity back up system 100 may be combined together and/or part of other devices and/or systems. In another embodiment of the present invention, excess load controller 103 may be a part of excess load dump 107.

It may be appreciated by a person with ordinary skill in the art that electrical back up system 100 is not limited to utility power grids. Electrical back up system 100 may be applied to nearly any electrical system requiring power load management such as, but not limited to, power supplies, energy storage systems, electric vehicle charging systems, fuel based generators, etc. In an alternative embodiment of the present invention, electrical back up system may be implemented in the charging system of an electric car.

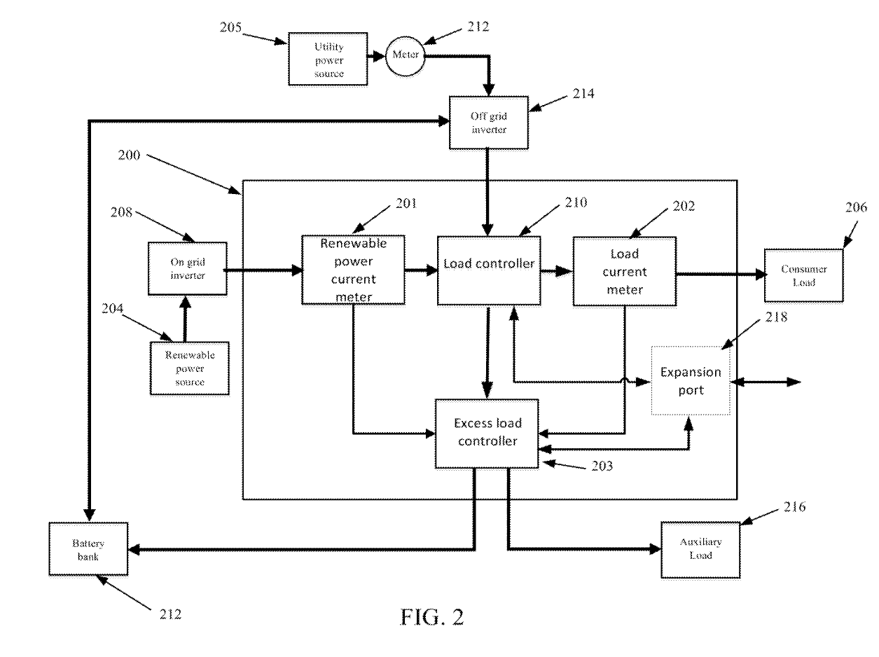

FIG. 2 illustrates an exemplary electrical back up system connected to a power grid, in accordance with an embodiment of the present invention. Electrical back up system 200 may receive power from a utility power source 205 and/or a renewable power source 204. Inverters located on and off a user's personal power grid may be used to convert power from power sources into usable forms such as alternating current (AC) or direct current (DC). An off grid inverter 214 may control power from utility power source 205 and convert power from a battery bank 212. An on grid inverter 208 may convert power from renewable power source 204. Power sent to electrical back up system 200 may be delivered to consumer load 206. Excess power within electrical back up system 200 may be sent to an auxiliary load 216 and/or an energy storage device such as, but not limited to, a battery bank 212. Additionally, battery bank 212 may be charged by power from utility power 205 that has been converted via off grid inverter 214.

During typical operation, power from a renewable power source 204 may be converted to AC power via an on grid inverter 208 coupled to renewable power source 204. AC power from on grid inverter 208 may be sent to electrical back up system 200 where it may be used to power consumer load 206. Similarly, electrical back up system 200 may draw power from a utility power source 205. Power from utility power source 205 may be metered by a power meter 212. Off grid inverter may convert DC power from battery bank 212 to AC power during a backup power mode. In a non-limiting example, battery bank 212 may supply power to supplement power from renewable power source 204 when utility power source 205 in not available. Off grid inverter may also bypass or disconnect from utility power source 205 during the backup power mode. In some alternate embodiments, backup system 200 may communicate with off grid inverter 214 and/or on grid inverter. In a non-limiting example, battery bank 212 may be tested by putting utility power source 205 and renewable power source 204 in an off line mode. Excess power may be sent to an auxiliary load 216 and/or a battery bank 212. Battery bank 212 may also be charged by power from utility power source 205 that has been converted by off grid inverter 214. In the present embodiment, battery bank 212 may be the primary load for excess load controller 203. In some embodiments, auxiliary load 216 may be coupled to a net meter. In these embodiments, excess load controller 203 may prevent net metering during a failure of utility power source 205. In some embodiments, auxiliary load 216 may be coupled to a load dump such as, but not limited to, fans, ac, heater, lights, etc.

When utility power source 205 is offline, power from battery bank 212 may be sent to off grid inverter 214 and converted into AC destined for electrical back up system 200. Off grid inverter 214 prevents any power from feeding back into the electrical grid that utility power source 205 is coupled to.

Further, during typical operation, backup system 200 may use power produced by on grid inverter 208 to provide consumer load 206. In a non-limiting example, where consumer load 206 is greater than on grid inverter 208 output, then off grid inverter 214 or utility power 205 may supplement that short coming. The excess load controller 203 may know to open circuit and not feed auxiliary load 216 or battery bank 212 any power. The backup system 200 may not demand more power from off grid inverter 214 or utility power 205 than consumer load 206 requires. When on grid Inverter 208 is over producing based on consumer load 206, the excess load controller 203 may determine whether to send power to battery bank 212 or auxiliary load 216 or both. In some alternate embodiments, backup system 200 may use battery bank 212 to supplement the short coming for a period of time based on a capacity of battery bank 212.

It may be appreciated by a person with ordinary skill in the art that battery bank 212 may be nearly any energy storage device and in any number or configuration. Battery bank 212 may be replaced with any energy storage device such as, but not limited to, mechanical storage devices, hydroelectric storage devices, etc. In the present embodiment, battery bank 212 may include any type of rechargeable battery elements. In another embodiment of the present invention, electrical back up system 200 may be coupled to a plurality of mechanical storage devices connected in parallel. In still another embodiment of the present invention, no battery bank 212 may be connected to electrical back up system 200 and all excess load is sent to auxiliary load 216.

It may be appreciated by a person with ordinary skill in the art that any number and type of consumer load 206 or auxiliary load 216 may be connected to electrical back up system 200. Multiple different types of loads such as, but not limited to, heating units, cooling units, energy storage units, lighting or any electrical appliance within a maximum power rating may be coupled to electrical back up system 200 as a consumer load 206 or an auxiliary load 216. In another embodiment of the present invention, no auxiliary load 216 is connected to electrical back up system 200 and all excess load power is sent to a battery bank 212.

It may be appreciated by a person with ordinary skill in the art that consumer load 206 and/or auxiliary load 216 may be another power grid or electric back up system 200. In an alternative embodiment of the present invention, consumer load 206 may be another electrical back up system 200 in order to create a hierarchy of failure isolated power systems.

It may be appreciated by a person with ordinary skill in the art that off grid inverter 214 and on grid inverter 208 may be any type of inverter suitable for the on grid applications. In some embodiments, if battery bank 212 is not used then off grid inverter may not be used.

In some embodiments, backup system 200 may include an expansion port 218. In some alternate embodiments, expansion port 218 may provide for bi-directional communication with an external system. In some alternate embodiments, the external system may receive operational information from renewable power current meter 201, load current meter 202, load controller 210, and excess load controller 203 for display to a user of the backup system 200. In some alternate embodiments, the external system may provide for controlling parameters of load controller 210 and excess load controller 203. In some other alternate embodiments, the external system may provide programming updates for backup system 200. In some other alternate embodiments, expansion port 218 may provide for communication with another back up system. I some alternate embodiments, expansion port 218 may be configured for wired and/or wireless communications. In some other alternate embodiments, expansion port 218 may communicate with a user's home automation system. In a non-limiting example, backup system 200 may be integrated with a home automation system for managing consumer load 206 during a backup power mode.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing adding electrical backup systems to a net metered electrical grid according to the present invention will be apparent to those skilled in the art. Various aspects of the invention have been described above by way of illustration, and the specific embodiments disclosed are not intended to limit the invention to the particular forms disclosed. The particular implementation of adding electrical backup systems to a net metered electrical grid may vary depending upon the particular context or application. By way of example, and not limitation, the addition of electrical backup systems to a net metered electrical grid described in the foregoing were principally directed to consumer power utility implementations; however, similar techniques may instead be applied to national power grids, electric vehicle charging stations, or power plant management systems, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a first input being configured to receive power produced from a renewable power source;
a second input being configured to receive utility power from a utility power source;
a first output being configured to output power to a consumer load; and
a second output being configured to output excess power to a load, wherein said excess power comprises an excess of power produced from the renewable power source after supplying the consumer load with power produced from the renewable power source.

2. The system as recited in claim 1, further comprising a renewable power current meter being configured for at least measuring an input current from the renewable power source.

3. The system as recited in claim 2, further comprising a load current meter being configured for at least measuring a load current to the customer load.

4. The system as recited in claim 3, further comprising an excess load controller being configured for at least controlling the flow of said excess power.

5. The system as recited in claim 1, further comprising a load controller being configured for at least passing power from said first input and said second input to said consumer load.

6. The system as recited in claim 4, in which said second input receives the utility power for supplementing the renewable power source.

7. The system as recited in claim 6, in which said excess load controller is further configured for passing at least a portion of said excess power to a battery bank.

8. The system as recited in claim 7, in which said second input is further configured for receiving battery power from the battery bank.

9. The system as recited in claim 8, in which said second input receives the battery power during a backup power mode.

10. The system as recited in claim 9, in which said second input is further configured for receiving the utility power and the battery power from an off grid inverter.

11. The system as recited in claim 1, in which said first input is further configured for receiving the power produced from the renewable power source from an on grid inverter.

12. The system as recited in claim 4, in which said renewable power current meter and said load current meter are in communication with said excess load controller.

13. The system as recited in claim 4, in which said excess load controller is further configured for passing at least a portion of said excess power to a load dump.

14. A system comprising:
means for receiving power produced from a renewable power source;
means for receiving utility power from a utility power source;
means for outputting power to a consumer load; and
means for outputting excess power to a load, wherein said excess power comprises an excess of power produced from the renewable power source after supplying the consumer load with power produced from the renewable power source.

15. The system as recited in claim 14, further comprising means for measuring an input current from the renewable power source.

16. The system as recited in claim 15, further comprising means for measuring a load current to the customer load.

17. The system as recited in claim 16, further means for controlling the flow of said excess power.

18. The system as recited in claim 14, further comprising means for passing power from said first input and said second input to said consumer load.

19. A system comprising:
a first input being configured to receive power produced from a renewable power source from an on grid inverter;
a renewable power current meter being configured for at least measuring an input current from the renewable power source;
a second input being configured to receive a utility power and a battery power from an off grid inverter, wherein said second input receives the utility power for supplementing the renewable power source and receives the battery power during a backup power mode;
a first output being configured to output power to a consumer load;
a load current meter being configured for at least measuring a load current to the customer load;
a second output being configured to output excess power to a load; and
an excess load controller being in communication with said renewable power current meter and said load current meter and being configured for at least controlling the flow of said excess power, said excess load controller being further configured for passing at least a portion of said excess power to a battery bank, wherein said excess power comprises an excess of power produced from the renewable power source after supplying the consumer load with power produced from the renewable power source.

20. The system as recited in claim 19, further comprising a load controller being configured for at least passing power from said first input and said second input to said consumer load.
